(19) United States
(12) Patent Application Publication
(10) Pub. No.: US 2018/0013278 A1
(43) Pub. Date: Jan. 11, 2018

(54) HYDRAULIC CABLE TENSIONING MACHINE

(71) Applicants: STATE GRID AC ENGINEERING CONSTRUCTION COMPANY, Beijing (CN); YANGZHOU XINYUANLIHE ELECTRIC TECHNOLOGY CO. Ltd, YANGZHOU (CN)

(72) Inventors: Lizheng WANG, Beijing (CN); Bin YAO, Beijing (CN); Yajing WANG, Beijing (CN)

(73) Assignees: STATE GRID AC ENGINEERING CONSTRUCTION COMPANY, Beijing (CN); YANGZHOU XINYUANLIHE ELECTRIC TECHNOLOGY CO. Ltd., Yangzhou (CN)

(21) Appl. No.: 15/293,235

(22) Filed: Oct. 13, 2016

(30) Foreign Application Priority Data
Jul. 11, 2016 (CN) 201610543672.6

(51) Int. Cl. H02G 7/02; F15B 15/02; F15B 13/044; F15B 13/04; F15B 13/02; H02G 1/04; F15B 11/08

(52) U.S. Cl. CPC H02G 7/02; H02G 1/04; F15B 15/02; F15B 11/08; F15B 13/0401; F15B 13/023; F15B 13/0442

(57) ABSTRACT

Embodiments of the present invention disclose a hydraulic cable tensioning machine, comprising a tension puller for tensioning a cable, a hydraulic motor for controlling the action of the tension puller, and a hydraulic driving system for driving the hydraulic motor to operate, wherein an output end of the hydraulic driving system is connected to an input end of the hydraulic motor, and a power output end of the hydraulic motor is connected to a power input end of the tension puller.

### CROSS REFERENCE TO RELATED APPLICATIONS

This application claims the benefit and priority of Chinese Patent Application No. 201610543672.6, filed on Jul. 11, 2016 and entitled HYDRAULIC CABLE TENSIONING MACHINE, which is hereby incorporated by reference herein in its entirety.

### FIELD OF THE INVENTION

The present invention relates to the technical field of special devices for construction of power transmission lines, including the technical field of special devices for hoisting in other industries, and in particular to a hydraulic cable tensioning machine.

### BACKGROUND

There are lots of hoisting tasks such as lifting, traction, tensioning and alignment during the construction of power transmission lines. Particularly, the stringing construction of power transmission lines is performed outdoors as high as above 20-200 m, and cables of the conductor and ground wires are long and heavy. At present, during site construction, cables are usually manually aligned by lever hoists, with 2-4 cm (6-9 T) every minute, thereby resulting in low speed, high labor intensity of operators and high overhead safety risk. In the case of cold icing weather or strong wind, operators will face higher safety risk, and the project progress will be restricted to some extent. Therefore, reducing the labor intensity of operators, effectively controlling potential safety hazards and improving the quality of project are always problems to be urgently solved in construction sites.

### SUMMARY OF THE INVENTION

Embodiments of the present invention disclose a hydraulic cable tensioning machine, including a tension puller for tensioning a cable, a hydraulic motor for controlling the action of the tension puller, and a hydraulic driving system for driving the hydraulic motor to operate, wherein:

an output end of the hydraulic driving system is connected to an input end of the hydraulic motor, and a power output end of the hydraulic motor is connected to a power input end of the tension puller.

### BRIEF DESCRIPTION OF THE DRAWINGS

The drawings described herein are used for providing further understanding of embodiments of the present invention and constitute a part of the embodiments of the present invention. Schematic embodiments and descriptions thereof are used for explaining the present invention, but do not constitute inappropriate limitations to the present invention. In the drawings:

FIG. 1 is a schematic diagram of the working principle of a hydraulic cable tensioning machine according to an embodiment of the present invention;

FIG. 2 is a structural diagram of a tension puller according to an embodiment of the present invention; and

FIG. 3 is a structural diagram of a hydraulic cable tensioning machine according to an embodiment of the present invention.

### REFERENCE NUMERALS

1: tension puller;
11: cable tensioning hoist;
12: chain;
13: hook;
2: speed reducer;
3: hydraulic motor;
4: hydraulic driving system;
41: oil tank;
42: filter;
43: conveying device;
431: hydraulic pump;
44: driving device;
45: overflow valve;
46: one-way valve;
47: pressure gauge;
48: reversing valve;
49: single-chip microcomputer; and
50: quick-change connector

### DETAILED DESCRIPTION OF THE PREFERRED EMBODIMENTS

For ease of understanding, the hydraulic cable tensioning machines according to embodiments of the present invention will be described below in details with reference to the drawings of the specification.

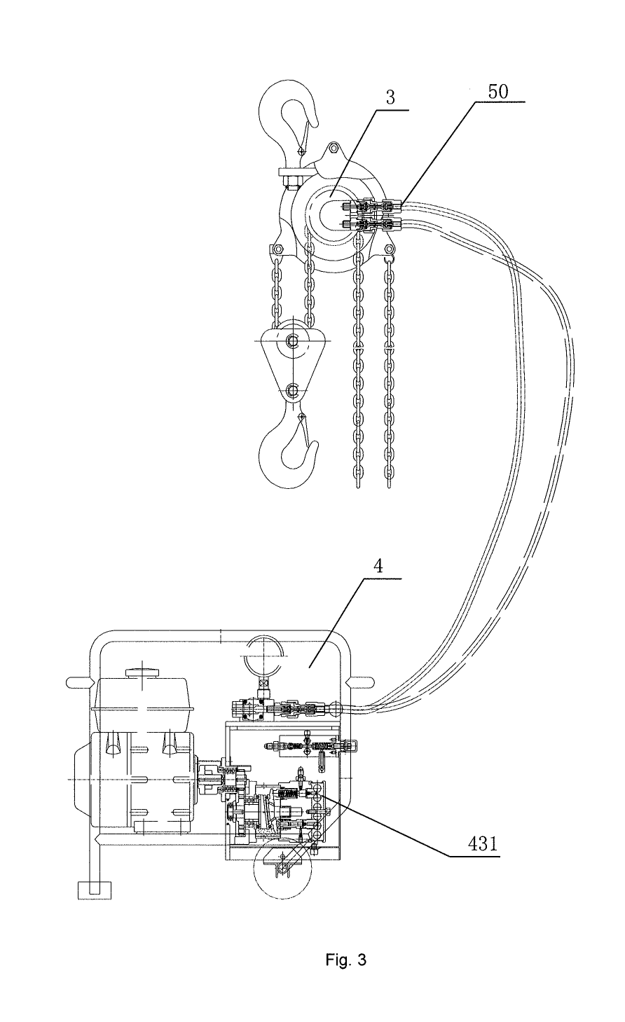

With reference to FIG. 1 and FIG. 3, in an embodiment, the hydraulic cable tensioning machine includes a tension puller 1 for tensioning a cable, a hydraulic motor 3 for controlling the action of the tension puller 1, and a hydraulic driving system 4 for driving the hydraulic motor 3 to operate, wherein the output end of the hydraulic driving system 4 is connected to the input end of the hydraulic motor 3, and the power output end of the hydraulic motor 3 is connected to the power input end of the tension puller 1.

During a specific implementation, the output end of the hydraulic driving system 4 is connected to the input end of the hydraulic motor 3, the On or Off of the hydraulic driving system 4 will lead to the running or stalling of the hydraulic motor 3, and the power output end of the hydraulic motor 3 is connected to the power input end of the tension puller 1. When the hydraulic motor 3 runs, the hydraulic motor 3 drives the tension puller 1 to operate so as to tension a power transmission cable which is connected to the tension puller 1 in advance, so that the cable tensioning operation of the hydraulic cable tensioning machine is accomplished.

In the hydraulic cable tensioning machine provided by this embodiment, by driving the hydraulic motor 3 to mechanically run merely through the hydraulic driving system 4 and outputting the mechanical power of the hydraulic motor 3, the tension puller 1 is allowed to accomplish the cable tensioning operation. However, during the cable tensioning process of the hydraulic cable tensioning machine, almost no operator is required to perform manual operations. Therefore, the hydraulic cable tensioning machine provided by this embodiment greatly reduces the labor intensity of operators, and also reduces the amount of operators for overhead operations.

Moreover, in a particularly severe operating environment, for example, in the case of cold icing weather or strong wind, power transmission cables may be tensioned by the hydraulic cable tensioning machine after they are connected to the hydraulic cable tensioning machine by operators, so that both the overhead operation time and the safety risk of the operators are reduced greatly.

In addition, by driving the hydraulic motor 3 to operate through the hydraulic driving system 4 and then causing the hydraulic motor 3 to drive the tension puller 1 to tension power transmission cables, in comparison to manually tensioning power transmission cables by operators by lever hoists in the prior art, the working efficiency is improved greatly.

It is to be noted that, the tension puller 1 in this embodiment is an existing conventional tension puller for tensioning a cable during the stringing construction of power transmission lines, generally including a single-ratchet tension puller and a dual-ratchet tension puller. But it is not limited thereto, as long as the tension puller is simple and portable and can be driven by a hydraulic motor to accomplish hoisting operations such as lifting, traction, tensioning and alignment during the construction of power transmission lines.

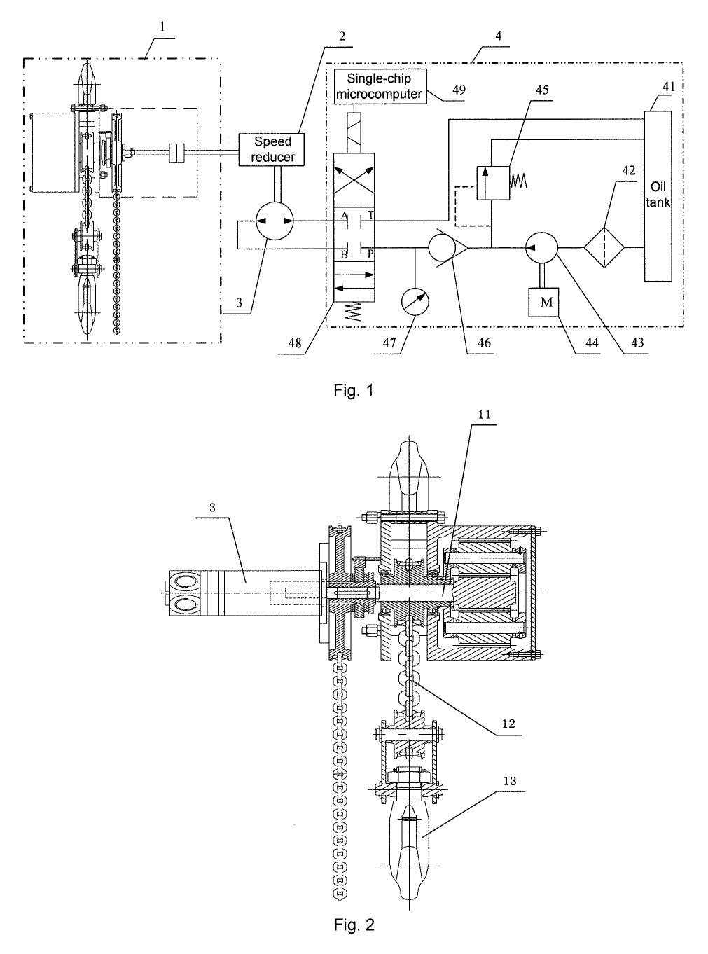

With reference to FIG. 2, this embodiment provides a specific structure of the tension puller 1. The tension puller 1 mainly consists of a cable tensioning hoist 11, a chain 12 and a hook 13, wherein the power input end of the cable tensioning hoist 11 is connected to the power output end of the hydraulic motor 3; the running of the cable tensioning hoist 11 is driven by the hydraulic motor 3; the chain 12 is fixed on the cable tensioning hoist 11; and the hook 13 is fixed on the chain 12. The chain 12 and the hook 13 are moved upward or downward when the cable tensioning hoist 11 runs, to perform hoisting operations on a power transmission cable, such as lifting, traction, tensioning and alignment.

The specific structure of the hydraulic motor 3 in this embodiment may be varied. To better realize the tensioning and loosening of a power transmission cable by the tension puller and to ensure the quality of tensioning during tensioning the power transmission cable, optionally, the hydraulic motor 3 is a bidirectional piston type motor. In addition, the specific operating parameters, for example, operating pressure, rotating speed, torque, power, etc., of the hydraulic motor 3 may be selected by those skilled in the art according to actual needs.

Further, to better match the rotating speed and torque of the hydraulic motor 3 with the rotating speed and torque of the tension puller 1, in this embodiment, the power output end of the hydraulic motor 3 is connected to the power input end of the tension puller 1 through a speed reducer 2.

When in selecting and mounting the speed reducer 2, a transmission ratio required between the hydraulic motor 3 and the tension puller 1 is determined according to the requirements on the rotating speed and torque of the tension puller 1 and in conjunction with the output rotating speed and output torque of the selected hydraulic motor 3, and an appropriate speed reducer 2 is selected to be serially connected between the tension puller 1 and the hydraulic motor 3 according to the transmission ratio. The specific structure of the speed reducer 2 may be any one of various existing structures of the speed reducer. The requirements on the rotating speed and torque of the tension puller 1 are selectively set according to actual needs, and both the structure type of the hydraulic motor 3 and the structure type of the speed reducer 2 may have various corresponding selections.

In addition, during the power transmission of the hydraulic tension puller, to effectively buffer the impact force resulted from heavy power transmission cables and reduce the vibrations caused by the high-speed running of the hydraulic motor 3, the connection between the speed reducer 2 and the power output end of the hydraulic motor 3 or between the speed reducer 2 and the power input end of the tension puller 1 may be specifically realized by a coupling.

To improve the working efficiency, with reference to FIG. 3, in this embodiment, optionally, the hydraulic driving system 4 is connected to the hydraulic motor 3 through a quick-change connector 50, so that operators may mount and debug the hydraulic cable tensioning machine timely and quickly.

Still referring to FIG. 1, the hydraulic driving system 4 includes an oil tank 41, a reversing valve 48 and a conveying device 43, wherein an input end of oil-way of the conveying device 43 is connected to the oil tank 41 while an output end thereof is connected to a pressurized oil port P of the reversing valve 48; and, an oil return port T of the reversing valve 48 is connected to the oil tank 41, and the hydraulic motor 3 is serially connected between a first working oil port A and a second working oil port B of the reversing valve 48.

Specifically, the oil tank 48 may be an open oil tank or a closed oil tank. When the oil tank 48 is an open oil tank, the input end of oil-way of the conveying device 43 and the oil return port T of the reversing valve 48 are directly connected to the oil tank 41. When the oil tank 48 is a closed oil tank, the input end of oil-way of the conveying device 43 is connected to an outlet end of the oil tank 41, and the oil return port T of the revering valve 48 is connected to an inlet port of the oil tank 41.

There may be various types of reserving valves 48, for example, mechanically-actuated reversing valves, electro-hydraulic directional control valves, etc. In this embodiment, the reversing valve 48 is a solenoid operated directional valve. The specific structure of the solenoid operated directional valve may be varied, for example, three-position four-way, three-position five-way, etc., and may be selected according to actual needs.

It is to be mentioned that the hydraulic driving system 4 may further include a single-chip microcomputer 49 for controlling the On/Off of the solenoid operated directional valve when the reversing valve 48 is a solenoid operated directional valve. For different environments for the stringing construction of power transmission cables or different locations in the same environment, the adjustment requirements on the length of power transmission cables are different. The single-chip microcomputer 49 is connected to the solenoid operated directional valve through a control bus, so that operators may be convenient to remotely control the tensioning of power transmission cables.

During a specific implementation, the single-chip microcomputer 49 directly controls the solenoid operated directional valve to turn on or off for different durations, so that the single-chip microcomputer 49 can indirectly control the speed reducer 2 to realize different strokes; and, the single-chip microcomputer 49 directly controls the solenoid operated directional valve to operate at different ON positions, so that the single-chip microcomputer 49 can indirectly control the speed reducer 2 to operate at different rotating speeds. In this way, by controlling the speed reducer 2, different strokes or different rotating speeds may be realized, and the tension puller 1 is caused to perform various different tensioning actions, so that various different adjustment requirements on the length of power transmission cables are satisfied and the adjustment in length and height of the power transmission cables is realized.

It is to be noted that the conveying device 43 is used for causing oil in the oil tank 41 to become pressurized oil, and conveying the pressurized oil to the pressurized oil port P of the reversing valve. The oil pressure of the pressurized oil should meet the requirements of the pressurized oil port P of the reversing valve on the oil pressure. When the oil tank 41 is a closed oil tank having pre-pressurized oil stored therein in advance and the oil pressure of the pre-pressurized oil can meet the requirements of the pressurized oil port P of the reversing valve on the oil pressure, the conveying device 43 may be any device capable of conveying the pre-pressurized oil. When the oil tank 41 is an open oil tank, the conveying device 43 should be capable of increasing the pressure of the oil in the oil tank 41 for conveying. Optionally, the conveying device 43 is a hydraulic pump 431. The specific structure type of the hydraulic pump 431 may be selected according to actual needs. Depending upon the determination whether the flow may be adjusted, the hydraulic pump 431 may be a quantitative hydraulic pump or a variable displacement hydraulic pump; while depending upon the specific structure, the hydraulic 431 may be a gear pump, a vane pump, a plunger pump, etc.

To ensure that the conveying device can operate stably, the allowable pressurization range of oil in the oil tank 41 is extended, so that the selectable range of the reversing valve 48 becomes larger. The hydraulic driving system 4 further includes a driving device 44 for driving the conveying device 43 to operate. The driving device 44 generally may be an engine or an electric motor. When the conveying device 43 is a hydraulic pump, in combination with the working environment of the stringing construction of power transmission cables, for the convenience of movement, optionally, the driving device 44 is an engine, so that the heat energy generated by the combustion of the fuel can be directly converted by the engine into mechanical energy for power outputting. Specifically, the engine may be a portable small gasoline engine.

To prevent the reverse flowing of oil from influencing the oil pressure of oil in the oil-way, a one-way valve 46 is provided between the output end of oil-way of the conveying device 43 and the pressurized oil port P of the reversing valve 48 so that oil in the oil-way can flow in the working direction only. When oil in the oil-way flows through the output end of oil-way of the conveying device 43 to the one-way valve 48, the valve body within the one-way valve 48 is opened for allowing oil to flow through. Whereas, when oil in the oil-way flows through the pressurized oil port P of the reversing valve 48 to the one-way valve 48, the valve body within the one-way valve 48 is closed for preventing oil from flowing through.

There are various types of one-way valves 46, for example, straight-through one-way valves or right-angle one-way valves. When the one-way valve 46 is a straight-through one-way valve, the one-way valve 46 is mounted in a threaded connection manner; however, when the one-way valve 46 is a right-angle one-way valve, the one-way valve 46 may be mounted in a threaded connection manner, in a flanged connection manner or in other manners.

To detect whether the oil pressure of oil conveyed to the pressurized oil port P of the reversing valve 48 meets the requirements of the pressurized oil port P of the reversing valve 48 on the oil pressure, a pressure gauge 47 for detecting the oil pressure within the oil-way is provided at the output end of the one-way valve 46. The specific type and structure of the pressure gauge 47 may be selected according to actual needs.

To ensure the safe operation of the hydraulic driving system, the hydraulic driving system 4 further includes an overflow valve 45. An input port of the overflow valve 45 is connected to the output end of oil-way of the conveying device 43, while an outlet end thereof is connected to the oil tank 41. There are various structure types of overflow valves 45. Generally, a direct-acting overflow valve or a pilot-operated overflow valve is used.

During a specific implementation, when the oil pressure of oil in the output end of oil-way of the conveying device 43 meets the requirements, that is, when the oil pressure is less than or equal to the set pressure of the overflow valve 45, the overflow valve 45 is closed. When the oil pressure of oil in the output end of oil-way of the conveying device 13 exceeds a specified limit, that is, the oil pressure is greater than the set pressure of the overflow valve 45, the overflow valve 45 is opened to overflow excessive oil into the oil tank 41. In this way, the oil pressure of oil in the output end of oil-way of the conveying device 43 is always maintained within a safe range, and the safe operation of the hydraulic driving system 4 is thus ensured.

To prevent impurities in oil from wearing various hydraulic elements and influencing the oil pressure of oil in the oil-way, a filter 42 for filtering impurities in oil is provided between the input end of oil-way of the conveying device 43 and the oil tank 41. Optionally, a detachable filter cartridge is provided inside the filter 42, and a filter screen of a certain specification is provided on the filter cartridge. When cleaning is required, it is desirable to take the filter cartridge out first and then clean or replace the filter screen. The specification of the filter screen may be selected according to actual needs.

Compared with the prior art, the hydraulic cable tensioning machine having the above structure may have the following beneficial effects.

The output end of the hydraulic driving system is connected to the input end of the hydraulic motor and the power output end of the hydraulic motor is connected to the power input end of the tension puller, so that the hydraulic driving system may drive the hydraulic motor to operate in order to cause the hydraulic motor to drive the tension puller to tension a power transmission cable. Thus, only by driving the mechanical operation of the hydraulic motor by the hydraulic driving system, the mechanical power of the hydraulic motor may be output to cause the tension puller to accomplish the cable tensioning operation. During the cable tensioning process of the hydraulic cable tensioning machine, almost no operator is required to perform manual operations. Therefore, in comparison to manually tensioning power transmission cables by operators by a tension puller in the prior art, the hydraulic cable tensioning machine provided by embodiments greatly reduces the labor intensity of operators. Moreover, in a particularly severe operating environment, for example, in the case of cold icing weather or strong wind, power transmission cables may be tensioned by the hydraulic cable tensioning machine after they are connected to the hydraulic cable tensioning machine by operators, so that both the overhead operation time and the safety risk of the operators are reduced greatly.

In the descriptions of the implementations, specific features, structures, materials or characteristics may be combined appropriately in any one or more embodiments or examples.

The foregoing descriptions merely show specific implementations of the embodiments of the present invention, and the protection scope of the present invention is not limited thereto. Any person of skill in the art may readily conceive of variations or replacements within the technical scope disclosed by the embodiments of the present invention, and these variations or replacements shall fall into the protection scope of the present invention. Accordingly, the protection scope of the present invention shall be subject to the protection scope of the claims.

What is claimed is:

1. A hydraulic cable tensioning machine, comprising a tension puller for tensioning a cable, a hydraulic motor for controlling the action of the tension puller, and a hydraulic driving system for driving the hydraulic motor to operate, wherein:
an output end of the hydraulic driving system is connected to an input end of the hydraulic motor, and a power output end of the hydraulic motor is connected to a power input end of the tension puller.

2. The hydraulic cable tightening machine according to claim 1, wherein the power output end of the hydraulic motor is connected to the power input end of the tension puller through a speed reducer.

3. The hydraulic cable tightening machine according to claim 1, wherein the hydraulic driving system comprises an oil tank, a reversing valve and a conveying device, wherein:
an input end of oil-way of the conveying device is connected to the oil tank, and an output end of oil-way of the conveying device is connected to a pressurized oil port of the reversing valve; and
an oil return port of the reversing valve is connected to the oil tank, and the hydraulic motor is serially connected between a first working oil port and a second working oil port of the reversing valve.

4. The hydraulic cable tightening machine according to claim 3, wherein a one-way valve is provided between the output end of oil-way of the conveying device and the pressurized oil port of the reversing valve.

5. The hydraulic cable tightening machine according to claim 4, wherein a pressure gauge for detecting the oil pressure within the oil-way is provided at an output end of the one-way valve.

6. The hydraulic cable tightening machine according to claim 3, wherein the hydraulic driving system further comprises an overflow valve;
an inlet end of the overflow valve is connected to the output end of oil-way of the conveying device; and
an outlet end of the overflow valve is connected to the oil tank.

7. The hydraulic cable tightening machine according to claim 3, wherein the hydraulic driving system further comprises a driving device which is connected to the conveying device and used for driving the conveying device to operate.

8. The hydraulic cable tightening machine according to claim 7, wherein the conveying device is a hydraulic pump and the driving device is an engine.

9. The hydraulic cable tightening machine according to claim 3, wherein a filter for filtering impurities in oil is provided between the input end of oil-way of the conveying device and the oil tank.

10. The hydraulic cable tightening machine according to claim 3, wherein the reversing valve is an solenoid operated directional valve, and the hydraulic system further comprises a single-chip microcomputer for controlling the on/off of the solenoid operated directional valve.
